(19) United States
(12) Patent Application Publication
(10) Pub. No.: US 2010/0036708 A1
(43) Pub. Date: Feb. 11, 2010

(54) APPARATUS AND METHOD FOR SCHEDULE SETTING IN A PORTABLE COMMUNICATION SYSTEM

(75) Inventors: Jae-Chul Lee, Suwon-si (KR); Won-Gi Lee, Suwon-si (KR)

Correspondence Address: Jefferson IP Law, LLP, 1130 Connecticut Ave., NW, Suite 420, Washington, DC, 20036, US

(73) Assignee: Samsung Electronics Co., Ltd., Suwon-si (KR)

(21) Appl. No.: 12/484,621

(22) Filed: Jun. 15, 2009

(30) Foreign Application Priority Data
Aug. 6, 2008 (KR) 10-2008-0076928

(51) Int. Cl. G06Q 10/00; G06F 3/048

(52) U.S. Cl. 705/9; 715/702; 715/810

(57) ABSTRACT

An apparatus and method for schedule setting in a portable communication system are provided. The apparatus includes an event manager for performing a process to set a schedule by appointing a duration of a day intended to perform schedule setting by a touch, or a process to set a schedule by a touch input defining a predefined menu input for the schedule setting.

### PRIORITY

This application claims the benefit under 35 U.S.C. §119(a) of a Korean patent application filed in the Korean Intellectual Property Office on Aug. 6, 2008 and assigned Serial No. 10-2008-0076928, the entire disclosure of which is hereby incorporated by reference.

### BACKGROUND OF THE INVENTION

1. Field of the Invention

The present invention relates to an apparatus and method for schedule setting in a portable communication system. More particularly, the present invention relates to an apparatus and method for simplifying a schedule setting process through a corresponding touch input.

2. Description of the Related Art

Recently, portable communication systems have become a necessity to most people and are therefore widely used. Accordingly, service providers and system manufacturers have been competitively developing products and services for the portable communication systems to differentiate their products and services from other enterprises.

For example, portable communication systems are now produced and serviced with a multimedia device enabling phone book, games, a short message, Electronic mail (E-mail), a morning wakeup call function, a Motion Picture Experts Group (MPEG)-1 Audio Layer 3 (MP3) player, a schedule management function, a digital camera, wireless Internet services and others.

More particularly, the conventional schedule management function of the portable communication systems is a supplementary function that is provided to address an inconvenience in which, whenever managing a schedule, a user has to directly take a memo using a tool, such as a note.

However, the above conventional schedule management function, although being a supplementary function providing many conveniences, fails to provide a convenience to a user because of its insufficient development. For example, when intending to set a schedule repeated everyday during the 1st to 31st days of a month, a user has to directly input a start day and an end day, and repeatedly designate the schedule. Accordingly, a problem exists in the schedule management function since a user cannot simply input a day for schedule setting and has to directly input a corresponding day.

Therefore, a need exists for an apparatus and method for simply and conveniently setting a corresponding day when setting the above repeated schedule.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for simplifying a schedule setting process in a portable communication system.

Another aspect of the present invention is to provide an apparatus and method for appointing, through a touch input, a day intended to perform schedule setting in a portable communication system.

Still another aspect of the present invention is to provide an apparatus and method for enabling schedule setting corresponding to a touch input and thus simplifying a schedule setting process in a portable communication system.

In accordance with an aspect of the present invention, an apparatus for schedule setting in a portable communication system is provided. The apparatus includes an event manager for performing a process to set a schedule by appointing a duration of a day intended to perform schedule setting by touch, or a process to set a schedule by a touch input defining a predefined menu input for the schedule setting.

In accordance with another aspect of the present invention, a method for schedule setting in a portable communication system is provided. The method includes performing schedule setting by appointing a duration of a day intended to perform schedule setting by a touch, or performing schedule setting by a touch input defining a predefined menu input for the schedule setting.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram illustrating a construction of a portable communication system performing an event setting process according to an exemplary embodiment of the present invention;

FIG. 2 is a flow diagram illustrating an event setting process of a portable communication system according to an exemplary embodiment of the present invention;

FIG. 3 is a flow diagram illustrating a schedule setting process of a portable communication system according to an exemplary embodiment of the present invention;

FIG. 4A is a diagram illustrating a display screen for selecting a day for schedule setting in a portable communication system according to an exemplary embodiment of the present invention;

FIG. 4B is a diagram illustrating a display screen for performing schedule setting for a day in a portable communication system according to an exemplary embodiment of the present invention;

FIG. 4C is a diagram illustrating a display screen for deleting a schedule applied to a set day in a portable communication system according to an exemplary embodiment of the present invention;

FIG. 4D is a diagram illustrating a display screen for confirming a preset schedule in a portable communication system according to an exemplary embodiment of the present invention;

FIG. 5 is a flow diagram illustrating a schedule setting process of a portable communication system according to an exemplary embodiment of the present invention;

FIG. 6A is a diagram illustrating a display screen for performing a touch input for setting a schedule in a portable communication system according to an exemplary embodiment of the present invention; and

FIG. 6B is a diagram illustrating a display screen for setting a schedule by a touch input in a portable communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide an apparatus and method for appointing, through a touch input, a day intended to perform schedule setting, for setting a touch input for schedule setting, and for simplifying a schedule setting process through a corresponding touch input in a portable communication system. Also, in the following description, an event setting request represents a request for performing schedule setting, schedule management, such as a memo, and phone number registration.

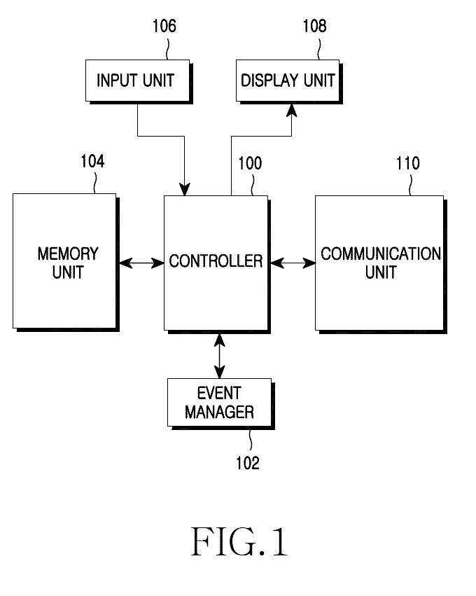

FIG. 1 is a block diagram illustrating a construction of a portable communication system performing an event setting process according to an exemplary embodiment of the present invention.

Referring to FIG. 1, the portable communication system may include a controller 100, an event manager 102, a memory unit 104, an input unit 106, a display unit 108 and a communication unit 110.

The controller 100 of the portable communication system performs a general operation of the portable communication system, for example, a process and control for voice telephony and data communication. In an exemplary implementation, the controller 100 determines whether a touch input is performed by a user of the portable communication system and confirms a day intended to perform an event setting. If a touch input is generated on a calendar of schedule management for output, the controller 100 determines a corresponding position as a start day for the event setting, and determines a position as an end day for the event setting based on movement of the touch input moving from the position where the touch input is generated. For example, if the controller 100 determines a touch input in a diagonal movement from ‘June 2nd’ to ‘June 11th’, the controller 100 may determine that an event is set to all days included between ‘June 2nd’ and ‘June 11th’.

Also, the controller 100 enables schedule setting corresponding to a predefined touch input. For example, if the controller determines a touch input, such as an ‘O’ movement, the controller 100 performs an operation for schedule setting. If the controller determines a touch input such as a ‘Δ’ movement, the controller 100 may perform an operation for anniversary setting.

The event manager 102 performs a process to set a corresponding event to a day appointed by a user of the portable communication system under instruction of the controller 100. For example, the event manager 102 performs a process to set a schedule corresponding to the day, output the contents of the schedule corresponding to the day, or delete the schedule corresponding to the day.

The memory unit 104 includes a Read Only Memory (ROM), a Random Access Memory (RAM), a flash ROM, and the like. The ROM stores a microcode of a program for processing and controlling the controller 100 and various reference data.

The RAM, a working memory of the controller 100, stores temporary data generated in execution of various programs. The flash ROM stores diverse types of updateable depository data, such as a phone book, an outgoing message, an incoming message, and the like.

The input unit 106 includes numeral key buttons ‘0’ to ‘9’, a menu button, a cancel button (delete), an OK button, a talk button, an end button, an Internet button, navigation key (or direction key) buttons, a plurality of function keys, such as a character input key, and the like. The input unit 106 provides key input data (e.g., an event setting request and the like), corresponding to a key pressed by a user, to the controller 100. Also, in an exemplary implementation, the input unit 106 includes a touch input unit for determining a touch input. Thus, the input unit 106 determines a touch input by a user and provides the touch input to the controller 100.

The display unit 108 displays state information generated during operation of the portable communication system, a limited number of characters, a large amount of moving pictures and still pictures, and the like. The display unit 108 may be a color Liquid Crystal Display (LCD).

The communication unit 110 performs a function of transmitting/receiving and processing a radio signal of data input/output through an antenna (not illustrated). For example, in a transmission mode, the communication unit 110 performs a function of channel-coding and spreading data to be transmitted. The communication unit 110 then performs Radio Frequency (RF)-processing and transmitting of the data. In a reception mode, the communication unit 110 performs a function of converting a received RF signal into a baseband signal, de-spreading and channel-decoding the baseband signal, and restores original data.

One or more functions of the event manager 102 may be implemented by the controller 100 of the portable communication system. However, the present invention is not limited thereto. For example, as illustrated, the event manager 102 may be separately provided and function as described above or the event manager 102 may be constructed to process all of these functions in the controller 100.

An exemplary apparatus for appointing, through a touch input, a day intended to perform schedule setting, for setting a touch input for schedule setting, and for simplifying a schedule setting process through a corresponding touch input in a portable communication system is described above. An exemplary method for appointing, through a touch input, a day intended to perform schedule setting, for setting a touch input for schedule setting, and for simplifying a schedule setting process through a corresponding touch input in the portable communication system is described below.

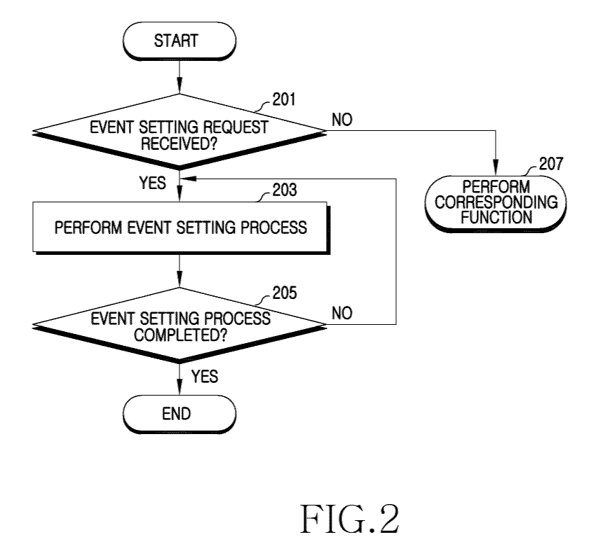

FIG. 2 is a flow diagram illustrating an event setting process of a portable communication system according to an exemplary embodiment of the present invention.

Referring to FIG. 2, in step 201, the portable communication system determines whether an event setting request is received. Here, the event setting request, which is a request for an event managing a schedule, may include at least one of a setting of an event repeated during a corresponding day, an output of contents of an event set to a corresponding day, and a deletion of an event set to a corresponding day. Also, the event setting process may be divided into a process of setting an event to a specific day and a process of setting an event through a specific touch input.

If the portable communication system does not receive the event setting request, the portable communication system performs a corresponding function (e.g., an idle mode) in step 207.

If the portable communication system receives the event setting request, the portable communication system proceeds to step 203 and performs a process of setting the event. The portable communication system performs one of a process of setting an event to a specific day and a process of setting an event through a specific touch input.

The process of setting the event to the specific day may include receiving a selection of a day intended to perform event setting from a user among days that are for output. At this time, the user of the portable communication system may select a day for setting the event by dragging the day intended for setting the event among days output on a display unit of the portable communication system, thus enabling a touch input. In other words, if the day intended for setting the event is ‘June 2nd’ to ‘June 11th’, the user of the portable communication system may touch a start day, that is, ‘June 2nd’, and perform a touch movement (e.g., a diagonal movement and the like) up to an end day, that is, up to ‘June 11th’ among days (e.g., a calendar of schedule management) that are for output. Thus, the day intended to set the event is selected.

Also, the process of setting the event through the specific touch input is a method for, at the time of the event setting process performance, performing (e.g., inputting a ‘Δ’ movement by a touch for an anniversary setting) an event setting process through a predefined touch input (e.g., ‘Δ’ representing an anniversary) in place of performing event setting through a menu selection process.

The portable communication system then determines if the event setting process is complete in step 205. If the event setting process is not complete, the portable communication system repeatedly performs the process of step 203.

If the event setting process is complete, the portable communication system terminates the process.

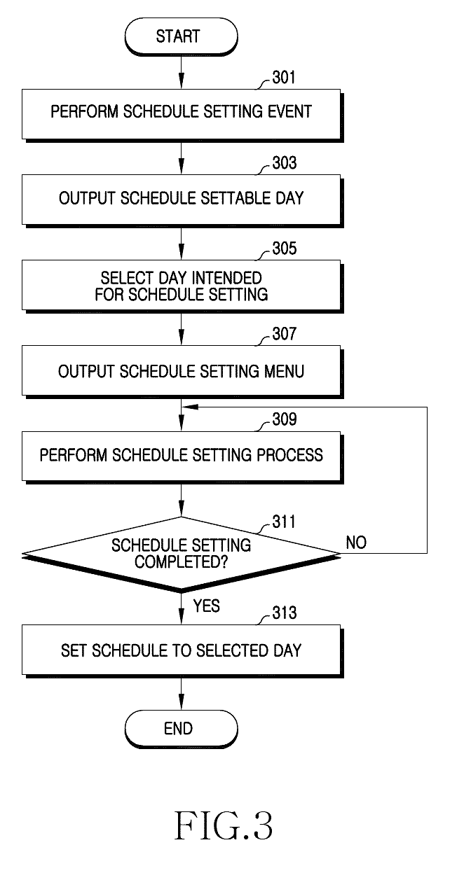

FIG. 3 is a flow diagram illustrating a schedule setting process of a portable communication system according to an exemplary embodiment of the present invention.

Referring to FIG. 3, in step 301, the portable communication system performs a schedule setting event process. The portable communication system then outputs a schedule settable calendar in step 301.

In step 305, the portable communication system receives a selection of a day intended to perform schedule setting from a user of the portable communication system. At this time, the user of the portable communication system may select the day intended for schedule setting by dragging the day on a display unit of the portable communication system, thus enabling a touch input. For example, if the day intended for schedule setting is ‘June 2nd’ to ‘June 11th’, the user of the portable communication system may select the day intended for schedule setting by either performing a touch movement (e.g., a diagonal movement and the like) up to an end day. Accordingly, the schedule setting may be performed by touching a start day, that is, ‘June 2nd’, up to an end date, that is, ‘June 11th’ among days (e.g., a calendar of schedule management) that are for output, or touching the start day and the end day by inputting a specific key.

In step 307, the portable communication system outputs a menu for schedule setting. Here, the menu for schedule setting represents a menu for inputting contents of a schedule intended for setting, supplementary information of an icon and the like.

The portable communication system performs a schedule setting process in step 309. The portable communication system then determines whether the schedule setting process is completed in step 311.

If the schedule setting process is not complete, the portable communication system repeatedly performs the process of step 309.

If the schedule setting process is complete, the portable communication system sets the schedule to the day selected in step 305 and terminates the process in step 313.

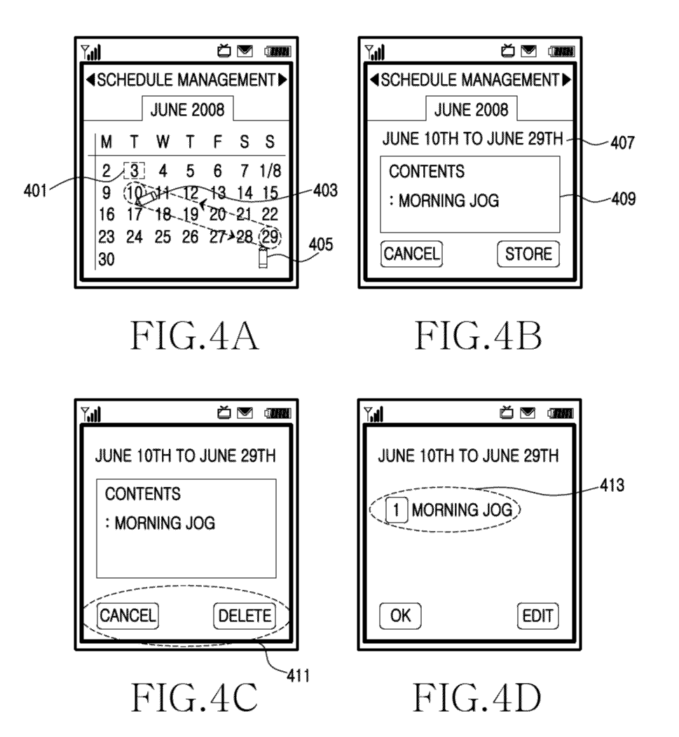

FIGS. 4A-4D are diagrams illustrating a schedule setting display screen for a portable communication system according to an exemplary embodiment of the present invention.

FIG. 4A is a diagram illustrating a display screen for selecting a day for schedule setting in a portable communication system according to an exemplary embodiment of the present invention.

Referring to FIG. 4A, the portable communication system is in a state of outputting a calendar of schedule management. As illustrated, the calendar indicates a current day, ‘June 3rd’ (401), as today.

As described above, a user of the portable communication system performs a touch input for selecting a day for schedule setting. For example, if the user of the portable communication system intends to set the same schedule from ‘June 10th’ to ‘June 29th’, the user of the portable communication system selects the day for schedule setting by performing a touch input for ‘June 10th’ (403), that is a start day of the schedule setting, and performing a dragging touch movement to ‘June 29th’ (405), that is an end day of the schedule setting.

Accordingly, the portable communication system determines that the user will apply the same schedule from ‘June 10th’ to ‘June 29th’.

FIG. 4B is a diagram illustrating a display screen for performing schedule setting for a day in a portable communication system according to an exemplary embodiment of the present invention.

Referring to FIG. 4B, as described above, a day for schedule setting may be selected in the portable communication system and the portable communication system outputs a schedule setting screen (i.e., a menu for schedule setting). Here, the schedule setting screen represents, as illustrated in FIG. 4B, a screen (409) for inputting information (e.g., schedule contents, supplementary information and the like) on a schedule corresponding to the set day (e.g., ‘June 10th’ to ‘June 29th’) (407).

FIG. 4C is a diagram illustrating a display screen for deleting a schedule applied to a set day in a portable communication system according to an exemplary embodiment of the present invention.

Referring to FIG. 4C, the portable communication system assumes that a preset schedule (e.g., schedule setting called a morning jog from ‘June 10th’ to ‘June 29th’) exists.

If the above-described set schedule is intended for deletion, a user of the portable communication system selects a day at which the preset schedule (e.g., the schedule setting called the morning jog from ‘June 10th’ to ‘June 29th’) exists. The day may be selected using a touch movement as described above.

If appointing a day as described-above to delete, the portable communication system performs a process to output the contents of a schedule preset to a corresponding day and a menu (411) to select deletion of the schedule.

FIG. 4D is a diagram illustrating a display screen for confirming a preset schedule in a portable communication system according to an exemplary embodiment of the present invention.

Referring to FIG. 4D, as described above, the portable communication system assumes that a preset schedule (e.g., schedule setting called a morning jog from ‘June 10th’ to ‘June 29th’) exists.

If the above-described set schedule is intended for confirmation, a user of the portable communication system selects a day at which a preset schedule (e.g., the schedule setting called the morning jog from ‘June 10th’ to ‘June 29th’) exits. The day may be selected using a touch movement as described above. If appointing a day as described-above, the portable communication system performs a process to output the contents (413) of a schedule preset to a corresponding day and a menu to edit the contents of the schedule.

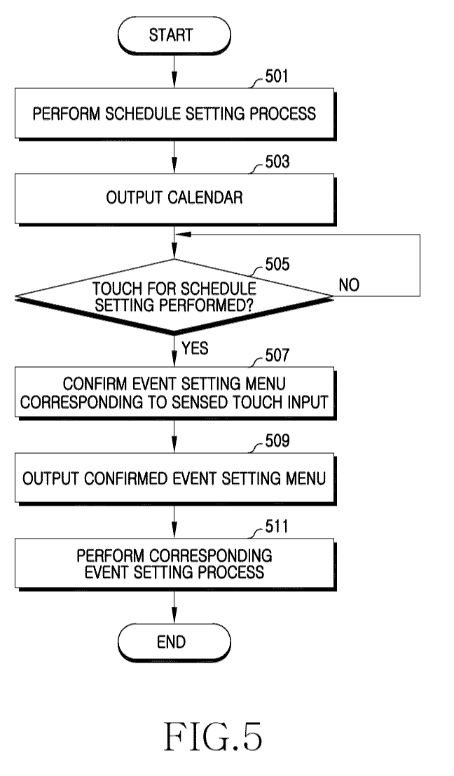

FIG. 5 is a flow diagram illustrating a schedule setting process of a portable communication system according to an exemplary embodiment of the present invention.

Referring to FIG. 5, in step 501, the portable communication system performs a schedule setting process and then outputs a calendar for schedule setting in step 503.

In step 505, the portable communication system determines whether a touch for schedule setting is performed.

Here, the touch for schedule setting, which is a touch input defining a predefined menu input for schedule setting, represents an input enabling a process of setting a schedule.

If the touch input for schedule setting is not performed, the portable communication system repeatedly performs the process of step 505.

If the touch input for schedule setting is performed, the portable communication system confirms an event setting menu corresponding to the touch input in step 507. Here, the event setting menu represents a menu for schedule setting. If a touch input, such as a ‘Δ’ movement, is set as a touch input setting an anniversary, the portable communication system may determine that the touch input is a user request for an anniversary setting.

In step 509, the portable communication system outputs the event setting menu confirmed in step 507 and then performs a corresponding event setting process in step 511.

The portable communication system then terminates the process.

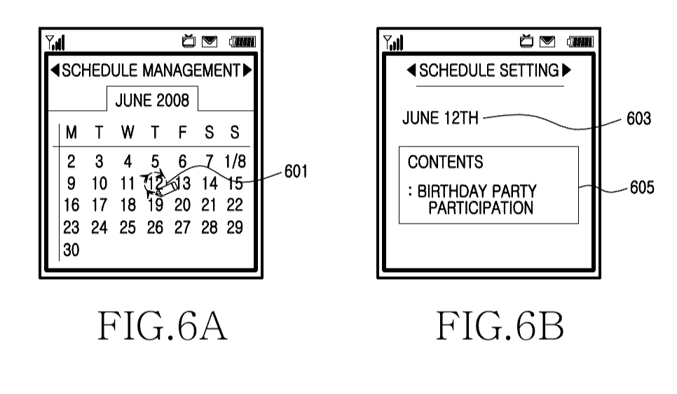

FIG. 6A is a diagram illustrating a display screen for performing a touch input for setting a schedule in a portable communication system according to an exemplary embodiment of the present invention.

Referring to FIG. 6A, a user of the portable communication system performs a touch input defining a predefined menu input for schedule setting.

If the portable communication system defines a touch input for schedule setting as an ‘O’ movement and define a touch input for anniversary setting as a ‘Δ’ movement, the user of the portable communication system performs a schedule setting process through the touch input (601), such as ‘O’.

FIG. 6B is a diagram illustrating a display screen for setting a schedule by a touch input in a portable communication system according to an exemplary embodiment of the present invention.

Referring to FIG. 6B, if the user of the portable communication system performs the touch input, such as ‘O’ as described in FIG. 6A, the portable communication system outputs a screen for the schedule setting to a corresponding day (603). Accordingly, the user of the portable communication system may set in a screen (605) a schedule called “birthday party participation” to the corresponding day.

As described above, exemplary embodiments of the present invention provides appointing, through a touch input, a day intended to perform schedule setting, setting a touch input for schedule setting, and simplifying a schedule setting process through a corresponding touch input in a portable communication system. Accordingly, a day input process implemented in a conventional schedule setting process is simplified.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for schedule setting in a portable communication system, the system comprising an event manager for performing one of a process to set a schedule by appointing a duration of a day intended to perform schedule setting by a touch and a process to set a schedule by a touch input defining a predefined menu input for the schedule setting.

2. The apparatus of claim 1, wherein the event manager appoints the duration of the day intended to perform the schedule setting by the touch and sets the schedule, by setting a start day and an end day of the day intended to set the schedule by the touch input, and by receiving and applying contents of an input of a schedule intended for setting to the day.

3. The apparatus of claim 2, wherein the event manager receives and applies the contents of the input of the schedule intended for setting to the day, by one of outputting a schedule preset to the day, deleting a schedule preset to the day and setting a repeated schedule to the day.

4. The apparatus of claim 2, wherein the event manager sets the start day and the end day of the day intended to set the schedule through the touch input, by one of touch-dragging from the start day to the end day of the day intended to set the schedule and touching the start day and the end day in a state of inputting a specific key.

5. The apparatus of claim 1, wherein, if a touch for schedule setting is received, the event manager sets a schedule corresponding to a schedule input menu corresponding to the touch input and sets the schedule by the touch input defining the predefined menu input for the schedule setting.

6. The apparatus of claim 5, wherein the schedule input menu corresponding to the touch input comprises at least one of an anniversary, an appointment, a conference, a weekly plan and a monthly plan.

7. The apparatus of claim 6, wherein the touch input defining the predefined menu input for the schedule setting is a touch input predefining a menu entry process necessary for setting of a corresponding schedule.

8. A method for schedule setting in a portable communication system, the method comprising one of performing schedule setting by appointing a duration of a day intended to perform schedule setting by a touch and performing schedule setting by a touch input defining a predefined menu input for the schedule setting.

9. The method of claim 8, wherein the performing of the schedule setting by appointing the duration of the day intended to perform the schedule setting by touch comprises:
setting a start day and an end day of the day intended to set the schedule by the touch input;
inputting a schedule intended for setting to the day; and
applying contents of the input schedule to the day.

10. The method of claim 9, wherein the applying of the input schedule to the day comprises one of outputting a schedule preset to the day, deleting a schedule preset to the day, and setting a repeated schedule to the day.

11. The method of claim 9, wherein the setting of the start day and the end day of the day intended to set the schedule by the touch input comprises at least one of dragging a touch input from the start day to the end day of the day intended to set the schedule, and touching the start day and the end day in a state of inputting a specific key.

12. The method of claim 8, wherein the performing of the schedule setting by the touch input defining the predefined menu input for the schedule setting comprises:
outputting a day for schedule setting;
if a touch for schedule setting is received, confirming a schedule input menu corresponding to the touch input; and
setting a schedule corresponding to the confirmed input menu.

13. The method of claim 12, wherein the schedule input menu corresponding to the touch input comprises at least one of an anniversary, an appointment, a conference, a weekly plan and a monthly plan.

14. The method of claim 13, wherein the touch input defining the predefined menu input for the schedule setting is a touch input predefining a menu entry process necessary for setting of a corresponding schedule.

15. A method for an event setting process in a portable communication system, the method comprising:
determining whether an event setting request is received; and
one of setting an event to a specific day and setting an event through a specific touch input.

16. The method of claim 15, wherein the event setting request is an event managing schedule that comprises one of a setting of an event repeated during a corresponding day, an output of contents of an event set to a corresponding day and a deletion of an event set to a corresponding day.

17. The method of claim 16, wherein the setting of the event to a specific day comprises enabling a touch input by selecting a day for setting the event by dragging the day intended for setting among days output on a display unit of the portable communication unit.

18. The method of claim 17, wherein the setting of the event through a specific touch input comprises:
outputting a day for the event setting;
if a touch for the event setting is received, confirming a schedule input menu corresponding to the touch input; and
setting an event corresponding to the confirmed input menu.

19. The method of claim 18, wherein the schedule input menu corresponding to the touch input comprises at least one of an anniversary, an appointment, a conference, a weekly plan and a monthly plan.

20. The method of claim 19, wherein the specific touch input is a touch input predefining a menu entry process necessary for setting of a corresponding event.
